(19) United States
(12) Patent Application Publication
(10) Pub. No.: US 2013/0325229 A1
(43) Pub. Date: Dec. 5, 2013

(54) POWER CONTROL DEVICE FOR ELECTRIC VEHICLE

(71) Applicant: AUTOMOTIVE RESEARCH & TESTING CENTER, Changhua County (TW)

(72) Inventors: Chien-An Chen, Changhua County (TW); Ting-Xing Lu, Changhua County (TW); Yen-Ting Cheng, Changhua County (TW)

(73) Assignee: AUTOMOTIVE RESEARCH & TESTING CENTER, Changhua County (TW)

(21) Appl. No.: 13/654,877

(22) Filed: Oct. 18, 2012

(30) Foreign Application Priority Data
May 29, 2012 (TW) 101119141

(51) Int. Cl. B60L 15/20

(52) U.S. Cl. 701/22

(57) ABSTRACT

A power control device is adapted for controlling output power of an electric vehicle including a motor, an accelerator pedal, and a sensing module that senses an accelerator pedal depth and a vehicle speed to provide a sensed pedal depth and a sensed vehicle speed. The power control device includes a condition judging module operable to make a judgment of at least one of an acceleration condition, a starting condition, and a load condition based on the sensed pedal depth and the sensed vehicle speed from the sensing module, and a control module operable to generate a torque output signal according to the judgment made by the condition judging module, so as to control an output torque of the motor.

### BACKGROUND OF THE INVENTION

1. Field of the Invention

The invention relates to power control techniques, and more particularly to a power control device for an electric vehicle.

2. Description of the Related Art

FIG. 1 shows an operation line 1 used in a conventional power control device for an electric vehicle. The operation line 1 illustrates a relation between a sensed accelerator pedal depth and a torque output signal of the electric vehicle. The conventional power control device is operable to obtain the torque output signal according to a sensed accelerator pedal depth and the operation line 1, and to convert the torque output signal into an output torque of a motor of the electric vehicle.

The conventional power control device has the following drawbacks:

1. When the electric vehicle starts, a static friction force must be overcome. If the electric vehicle does not have a slow-movement design, the conventional power control scheme may result in a slow start of the electric vehicle, especially for a heavy electric vehicle.

2. When the electric vehicle accelerates, the conventional power control device may not result in an obvious feeling of acceleration because of a small accelerating force of the electric vehicle.

3. When the accelerator pedal depth is not changed, a change of a road slope may result in a load change of the electric vehicle, so that the torque output signal from the conventional power control device may be too large or too small, resulting in undesired speed change of the electric vehicle.

### SUMMARY OF THE INVENTION

Therefore, an object of the present invention is to provide a power control device that can overcome at least one of the above drawbacks of the prior art.

According to the present invention, a power control device is for controlling output power of an electric vehicle. The electric vehicle includes a motor, an accelerator pedal, and a sensing module. The sensing module is operable to sense a pedal depth of the accelerator pedal to provide a sensed pedal depth, and a vehicle speed of the electric vehicle to provide a sensed vehicle speed. The power control device comprises:

a condition judging module to be coupled to the sensing module and operable to make a judgment of at least one of an acceleration condition, a starting condition, and a load condition based on at least one of the sensed pedal depth and the sensed vehicle speed; and

a control module coupled to the condition judging module, to be coupled to the sensing module, and operable to generate a torque output signal according to the judgment made by the condition judging module and at least one of the sensed pedal depth and the sensed vehicle speed, wherein the torque output signal is for controlling an output torque of the motor.

For making the judgment of the acceleration condition, the condition judging module is operable to obtain a depth variation value according to the sensed pedal depth and a reference pedal depth, and to determine which one of an accelerating state and a non-accelerating state the electric vehicle is in according to the sensed pedal depth and the depth variation value.

For making the judgment of the starting condition, the condition judging module is operable to determine which one of a static starting state, a low-speed starting state, and a non-starting state the electric vehicle is in according to the sensed vehicle speed.

For making the judgment of the load condition, the condition judging module is operable to determine which one of a light load state, a heavy load state, and a preset load state the electric vehicle is in according to the sensed pedal depth and the sensed vehicle speed.

### BRIEF DESCRIPTION OF THE DRAWINGS

Other features and advantages of the present invention will become apparent in the following detailed description of the preferred embodiment with reference to the accompanying drawings, of which:

FIG. 1 is a plot showing a relation between a sensed accelerator pedal depth and a torque output signal of a conventional power control device of an electric vehicle;

FIG. 2 is a block diagram illustrating an electric vehicle including a preferred embodiment of the power control device according to the present invention;

FIG. 3 is a block diagram illustrating the preferred embodiment of the power control device according to the present invention;

FIG. 4 is a plot showing a relation between a sensed pedal depth, a basic control signal, and an acceleration compensation signal of the preferred embodiment;

FIG. 5 is a plot showing a relation between a sensed vehicle speed and a starting compensation signal of the preferred embodiment;

FIG. 6 is a plot showing a relation between a sensed motor temperature and a motor temperature factor of the preferred embodiment;

FIG. 7 is a plot showing a relation between a sensed battery voltage and a battery voltage factor of the preferred embodiment;

FIG. 8 is a plot showing a relation between a sensed battery temperature and a battery temperature factor of the preferred embodiment; and

FIG. 9 is a plot showing a relation between a sensed battery residual power and a battery residual power factor of the preferred embodiment.

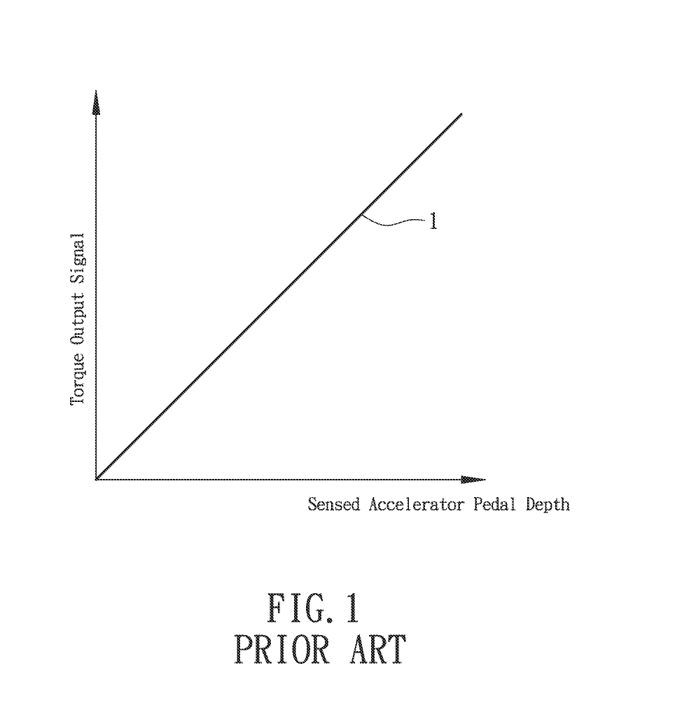

### DETAILED DESCRIPTION OF THE PREFERRED EMBODIMENT

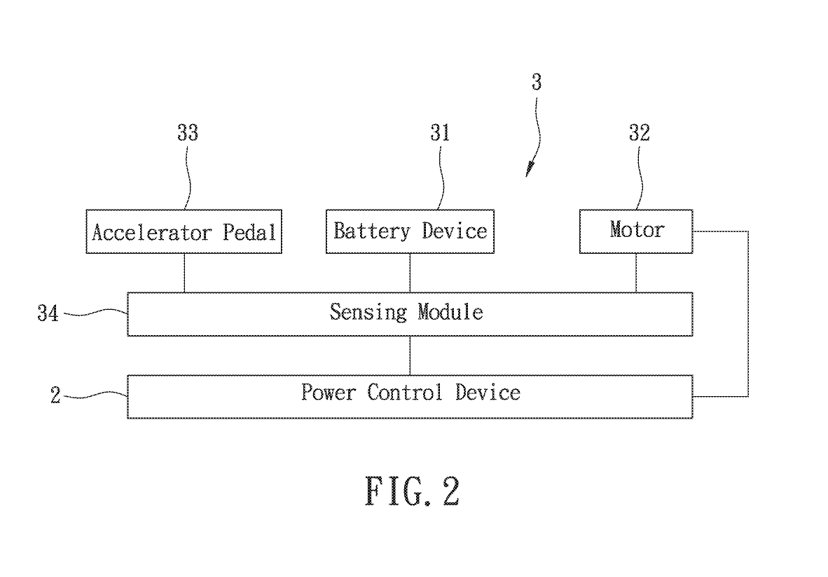

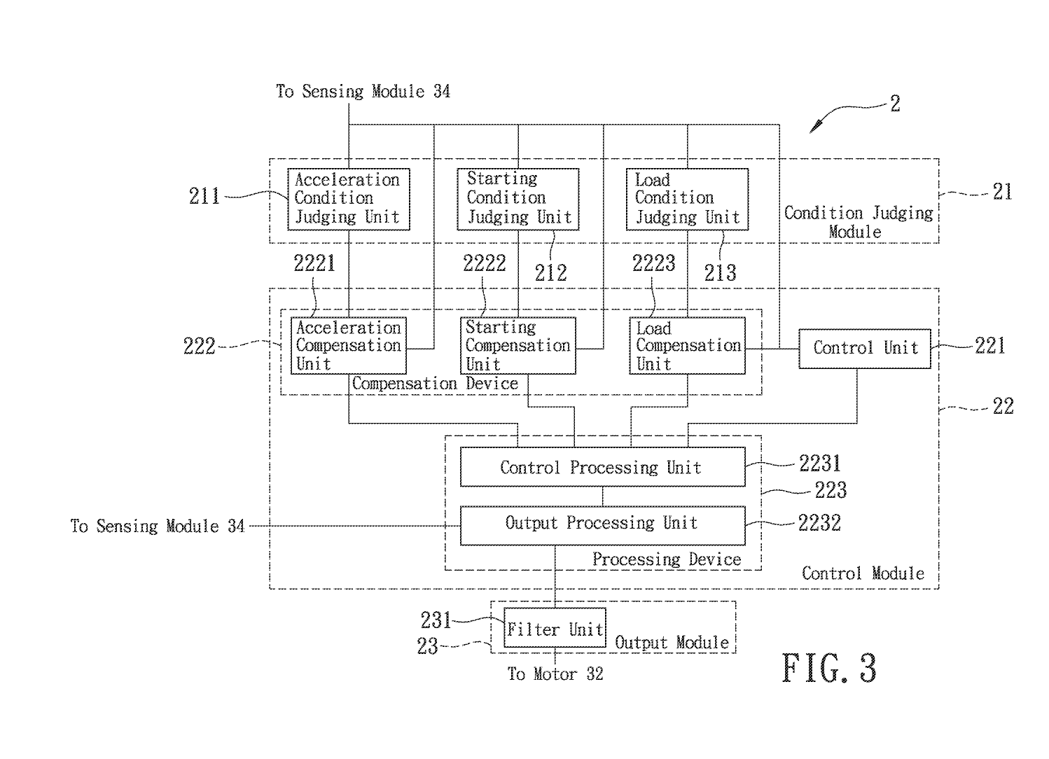

Referring to FIG. 2 and FIG. 3, the preferred embodiment of the power control device 2 according to this invention is adapted for controlling output power of an electric vehicle 3. The electric vehicle 3 includes a battery device 31, a motor 32, an accelerator pedal 33, and a sensing module 34. The sensing module 34 is operable to sense a pedal depth of the accelerator pedal 33 to provide a sensed pedal depth, a vehicle speed of the electric vehicle 3 to provide a sensed vehicle speed, a temperature of the motor 32 to provide a sensed motor temperature, a voltage of the battery device 31 to provide a sensed battery voltage, a temperature of the battery device 31 to provide a sensed battery temperature, and a residual power of the battery device 31 to provide a sensed battery residual power. The preferred embodiment of the power control device 2 includes a condition judging module 21, a control module 22, and an output module 23.

The condition judging module 21 includes an acceleration condition judging unit 211, a starting condition judging unit 212, and a load condition judging unit 213.

The acceleration condition judging unit 211 receives the sensed pedal depth from the sensing module 34, and is operable to obtain a depth variation value according to the sensed pedal depth and a reference pedal depth, and to determine which one of an accelerating state and a non-accelerating state the electric vehicle 3 is in according to the sensed pedal depth and the depth variation value. In addition, the acceleration condition judging unit 211 is operable to update the reference pedal depth according to the sensed pedal depth when determining which one of an accelerating state and a non-accelerating state the electric vehicle is in.

In this embodiment, for making the judgment of the acceleration condition, the acceleration condition judging unit 211 operates as follows:

The acceleration condition judging unit 211 judges that the electric vehicle 3 is in the accelerating state when the depth variation value is greater than a preset value, and sets an initial pedal depth using the reference pedal depth when the condition judging module judges that the electric vehicle 3 has changed from the non-accelerating state to the accelerating state.

The acceleration condition judging unit 211 judges that the electric vehicle 3 is in the accelerating state when the depth variation value is less than the preset value and the sensed pedal depth is greater than the initial pedal depth.

The acceleration condition judging unit 211 judges that the electric vehicle 3 is in the non-accelerating state and sets the initial pedal depth as 0 when the depth variation value is less than the preset value and the sensed pedal depth is less than the initial pedal depth.

The starting condition judging unit 212 receives the sensed vehicle speed from the sensing module 34, and is operable to determine which one of a static starting state, a low-speed starting state, and a non-starting state the electric vehicle 3 is in according to the sensed vehicle speed.

In this embodiment, for making the judgment of the starting condition, the starting condition judging unit 212 operates as follows:

The starting condition judging unit 212 judges that the electric vehicle 3 is in the static starting state when the sensed vehicle speed is less than a first preset speed.

The starting condition judging unit 212 judges that the electric vehicle 3 is in the low-speed starting state when the sensed vehicle speed is between the first preset speed and a second preset speed larger than the first preset speed.

The starting condition judging unit 212 judges that the electric vehicle 3 is in the non-starting state when the sensed vehicle speed is larger than the second preset speed.

The load condition judging unit 213 receives the sensed pedal depth and the sensed vehicle speed from the sensing module 34, and is operable to determine which one of a light load state, a heavy load state, and a preset load state the electric vehicle 3 is in according to the sensed pedal depth and the sensed vehicle speed.

In this embodiment, the load condition judging unit 213 has information of a vehicle speed reference curve which may be described by a function. The vehicle speed reference curve describes a preset relation between the pedal depth of the accelerator pedal 33 and the vehicle speed of the electric vehicle 3. For making the judgment of the load condition, the load condition judging unit 213 operates as follows:

The load condition judging unit 213 judges that the electric vehicle 3 is in the light load state when the sensed vehicle speed is larger by at least a preset difference from a preset speed that corresponds to the sensed pedal depth according to the vehicle speed reference curve.

The load condition judging unit 213 judges that the electric vehicle 3 is in the heavy load state when the sensed vehicle speed is smaller by at least the preset difference from the preset speed that corresponds to the sensed pedal depth according to the vehicle speed reference curve.

The load condition judging unit 213 judges that the electric vehicle 3 is in the preset load state when the sensed vehicle speed is not larger by at least the preset difference from the preset speed that corresponds to the sensed pedal depth according to the vehicle speed reference curve and is not smaller by at least the preset difference from the preset speed that corresponds to the sensed pedal depth according to the vehicle speed reference curve.

The control module 22 includes a control unit 221, a compensation device 222, and a processing device 223. The compensation device 222 includes an acceleration compensation unit 2221, a starting compensation unit 2222, and a load compensation unit 2223. The processing unit 223 includes a control processing unit 2231 and an output processing unit 2232.

The control unit 221 receives the sensed pedal depth from the sensing module 34, and is operable to generate a basic control signal based upon the sensed pedal depth.

The acceleration compensation unit 2221 receives the judgment of the acceleration condition from the acceleration condition judging unit 211, receives the sensed pedal depth from the sensing module 34, and is operable to perform acceleration compensation accordingly. During the acceleration compensation, the acceleration compensation unit 2221 operates as follows:

When the electric vehicle 3 is judged to be in the accelerating state, the acceleration compensation unit 2221 generates an acceleration compensation signal having a value greater than that of the basic control signal according to the sensed pedal depth.

When the electric vehicle 3 is judged to be in the non-accelerating state, the acceleration compensation unit 2221 generates the acceleration compensation signal having a value of zero.

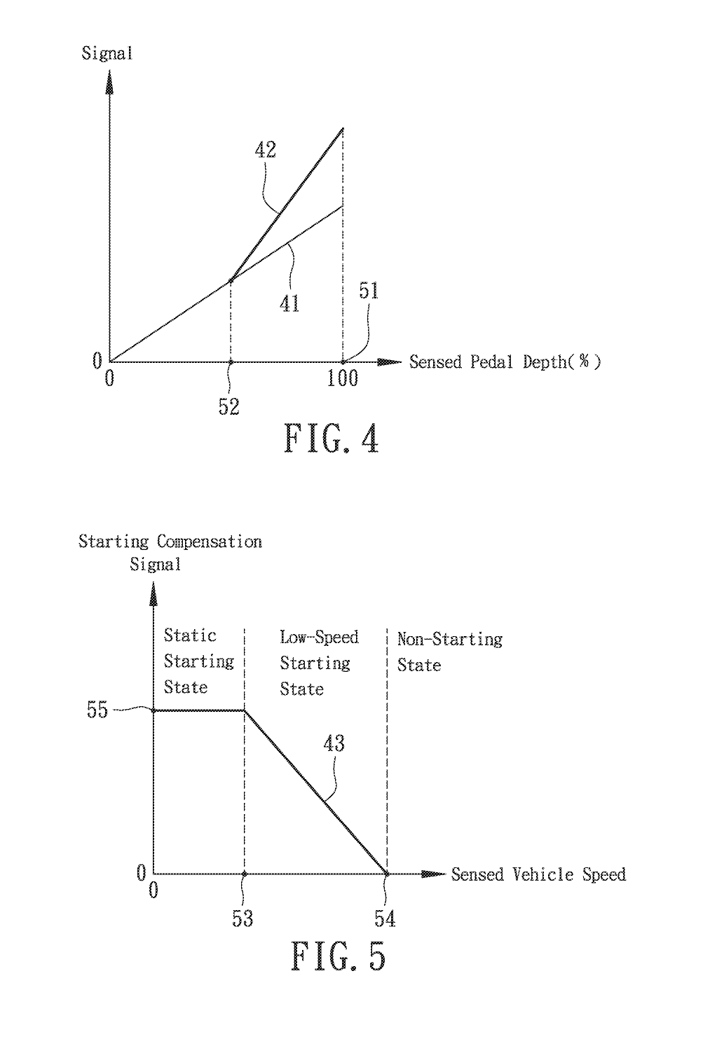

Referring to FIG. 4, a relation between the sensed pedal depth and the basic control signal is illustrated using a line 41, and a relation between the sensed pedal depth and the acceleration compensation signal is illustrated using a line 42. A maximum pedal depth of the accelerator pedal 33 is denoted using a point 51, and the initial pedal depth is denoted using a point 52. It should be noted that the relation between the sensed pedal depth and the basic control signal may be non-linear, so that the line 41 may be a curve. Similarly, the relation between the sensed pedal depth and the acceleration compensation signal may be non-linear, so that the line 42 may be a curve.

The starting compensation unit 2222 receives the judgment of the starting condition from the starting condition judging unit 212, receives the sensed vehicle speed from the sensing module 34, and is operable to perform starting compensation accordingly. During the starting compensation, the starting compensation unit 2222 operates as follows:

When the electric vehicle 3 is judged to be in the static starting state, the starting compensation unit 2222 generates a starting compensation signal having a preset compensation value.

When the electric vehicle 3 is judged to be in the low-speed starting state, the starting compensation unit 2222 generates the starting compensation signal having a value between 0 and the preset compensation value according to the sensed vehicle speed. The value of the starting compensation signal becomes smaller with increase of the sensed vehicle speed.

When the electric vehicle 3 is judged to be in the non-starting state, the starting compensation unit 2222 generates the starting compensation signal having a value of zero.

Referring to FIG. 5, a relation between the sensed vehicle speed and the starting compensation signal is illustrated using a line 43. The first preset speed is denoted using a point 53, the second preset speed is denoted using a point 54, and the preset compensation value is denoted using a point 55. It should be noted that, when the starting condition judging unit 212 judges that the electric vehicle 3 is in the static starting state, the starting compensation signal may not be a constant value for different vehicle speeds. Moreover, when the starting condition judging unit 212 judges that the electric vehicle 3 is in the low-speed starting state, the relation between the sensed vehicle speed and the starting compensation signal may be non-linear.

The load compensation unit 2223 receives the judgment of the load condition from the load condition judging unit 213, receives the sensed pedal depth from the sensing module 34, and is operable to perform load compensation accordingly. During the load compensation, the load compensation unit 2223 operates as follows:

When the electric vehicle 3 is judged to be in the light load state, the load compensation unit 2223 generates a load compensation signal having a value smaller than that of the basic control signal according to the sensed pedal depth.

When the electric vehicle 3 is judged to be in the heavy load state, the load compensation unit 2223 generates the load compensation signal having a value greater than that of the basic control signal according to the sensed pedal depth.

When the electric vehicle 3 is judged to be in the preset load state, the load compensation unit 2223 generates the load compensation signal having a value of zero.

The control processing unit 2231 receives the acceleration compensation signal from the acceleration compensation unit 2221, receives the starting compensation signal from the starting compensation unit 2222, receives the load compensation signal from the load compensation unit 2223, receives the basic control signal from the control unit 221, and is operable to obtain a compensation result based on a sum of the acceleration compensation signal, the starting compensation signal, and the load compensation signal. The control processing unit 2231 is further operable to output the compensation result as a torque control signal when the compensation result is different from a compensation threshold value, and to output a sum of the compensation result and the basic control signal as the torque control signal when the compensation result is equal to the compensation threshold value. In this embodiment, the compensation threshold value is equal to the starting compensation signal.

The output processing 2232 receives the torque control signal from the control processing unit 2231, receives the sensed motor temperature, the sensed battery voltage, the sensed battery temperature, and the sensed battery residual power from the sensing module 34, and is operable to generate a torque limit signal accordingly. The output processing 2232 is further operable to compare the torque control signal and the torque limit signal, and to output a smaller one of the torque control signal and the torque limit signal as a torque output signal. The torque output signal is for controlling an output torque of the motor 32.

In this embodiment, the output processing unit 2232 is operable to generate a motor temperature factor between 0 and 1 according to the sensed motor temperature, to generate a battery voltage factor between 0 and 1 according to the sensed battery voltage, to generate a battery temperature factor between 0 and 1 according to the sensed battery temperature, and to generate a battery residual power factor between 0 and 1 according to the sensed battery residual power. The output processing unit 2232 then multiplies the motor temperature factor, the battery voltage factor, the battery temperature factor, the battery residual power factor, and a preset upper limit value together to obtain the torque limit signal that ranges between 0 and the preset upper limit value.

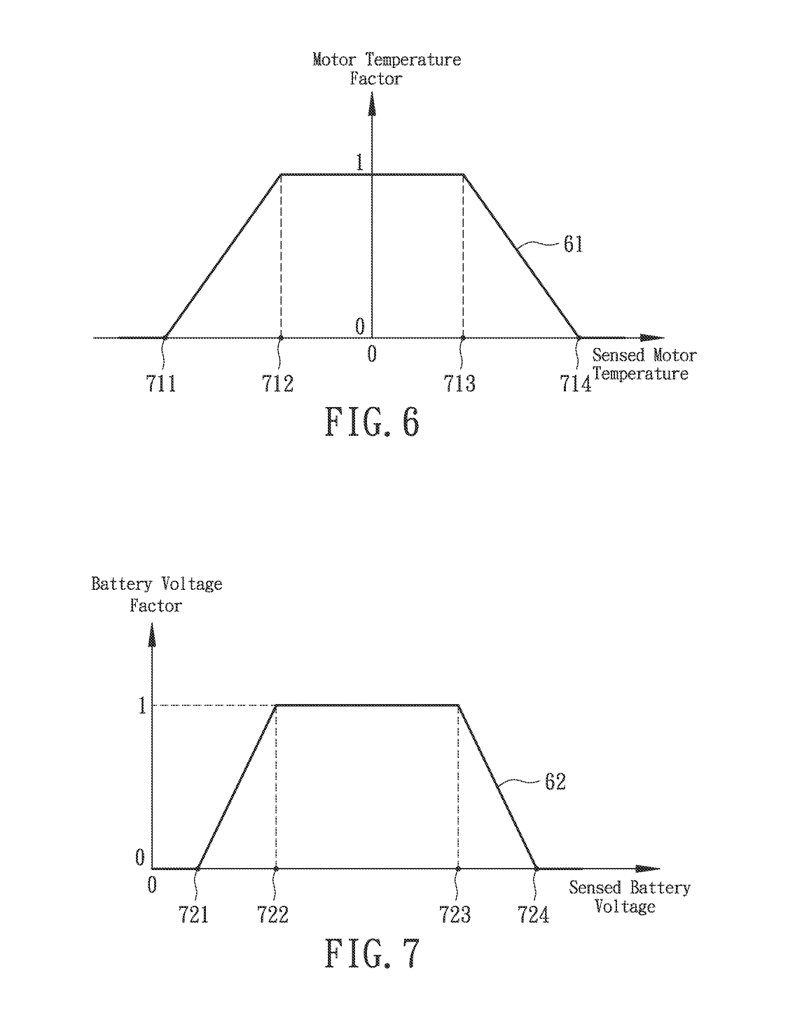

Referring to FIG. 6, the output processing unit 2232 generates the motor temperature factor using the line 61 that illustrates a relation between the sensed motor temperature and the motor temperature factor. Points 711 to 714 denote first to fourth preset temperatures arranged from the lowest one to the highest one. The motor temperature factor is 0 when the sensed motor temperature is smaller than the first preset temperature or larger than the fourth preset temperature. The motor temperature factor is 1 when the sensed motor temperature is between the second and third preset temperatures. The motor temperature factor is between 0 and 1, and becomes larger with increase of the sensed motor temperature when the sensed motor temperature is between the first and second preset temperatures. The motor temperature factor is between 0 and 1, and becomes smaller with increase of the sensed motor temperature when the sensed motor temperature is between the third and fourth preset temperatures. It should be noted that the relation between the sensed motor temperature and the motor temperature factor may be non-linear when the sensed motor temperature is between the first and second preset temperatures or between the third and fourth preset temperatures.

Referring to FIG. 7, the output processing unit 2232 generates the battery voltage factor using the line 62 that illustrates a relation between the sensed battery voltage and the battery voltage factor. Points 721 to 724 denote first to fourth preset voltages arranged from the lowest one to the highest one. The battery voltage factor is 0 when the sensed battery voltage is smaller than the first preset voltage or larger than the fourth preset voltage. The battery voltage factor is 1 when the sensed battery voltage is between the second and third preset voltages. The battery voltage factor is between 0 and 1, and becomes larger with increase of the sensed battery voltage when the sensed battery voltage is between the first and second preset voltages. The battery voltage factor is between 0 and 1, and becomes smaller with increase of the sensed battery voltage when the sensed battery voltage is between the third and fourth preset voltages. It should be noted that the relation between the sensed battery voltage and the battery voltage factor may be non-linear when the sensed battery voltage is between the first and second preset voltages or between the third and fourth preset voltages.

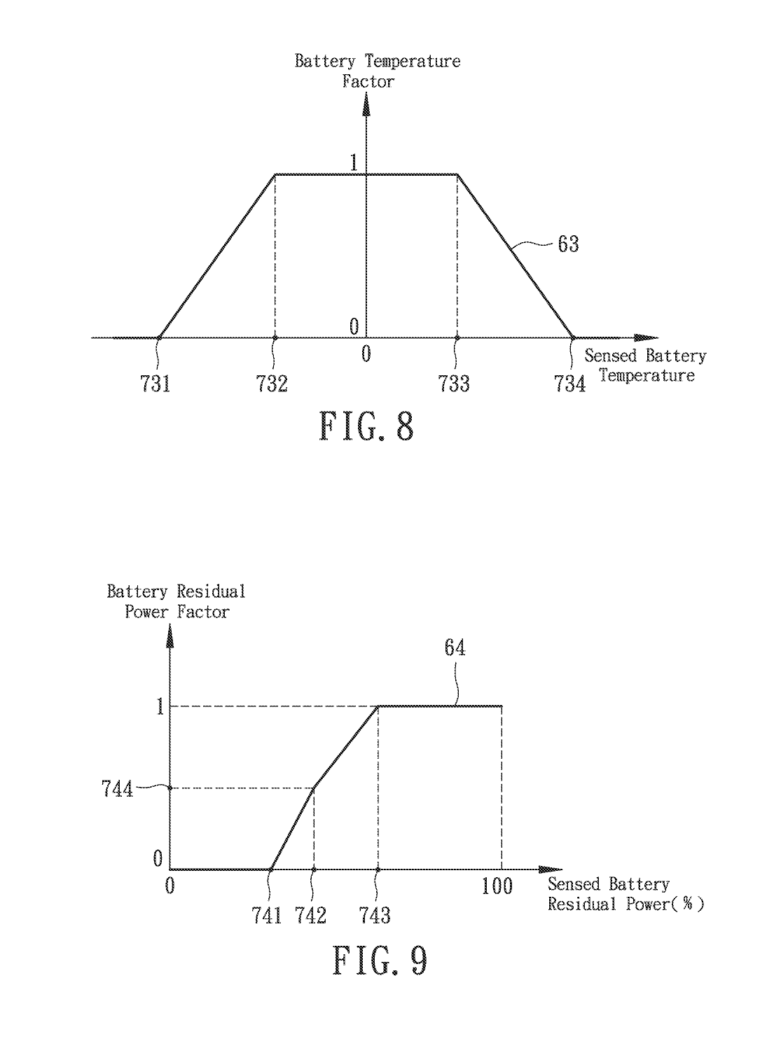

Referring to FIG. 8, the output processing unit 2232 generates the battery temperature factor using the line 63 that illustrates a relation between the sensed battery temperature and the battery temperature factor. Points 731 to 734 denote fifth to eighth preset temperatures arranged from the lowest one to the highest one. The battery temperature factor is 0 when the sensed battery temperature is smaller than the fifth preset temperature or larger than the eighth preset temperature. The battery temperature factor is 1 when the sensed battery temperature is between the sixth and seventh preset temperatures. The battery temperature factor is between 0 and 1, and becomes larger with increase of the sensed battery temperature when the sensed battery temperature is between the fifth and sixth preset temperatures. The battery temperature factor is between 0 and 1, and becomes smaller with increase of the sensed battery temperature when the sensed battery temperature is between the seventh and eighth preset temperatures. It should be noted that the relation between the sensed battery temperature and the battery temperature factor may be non-linear when the sensed battery temperature is between the fifth and sixth preset temperatures or between the seventh and eighth preset temperatures.

Referring to FIG. 9, the output processing unit 2232 generates the battery residual power factor using the line 64 that illustrates a relation between the sensed battery residual power and the battery residual power factor. Points 741 to 743 denote first to third preset residual power values arranged from the lowest one to the highest one, and a medium value between 0 and 1 is denoted using a point 744. The battery residual power factor is 0 when the sensed battery residual power is smaller than the first preset residual power value. The battery residual power factor is 1 when the sensed battery residual power is larger than the third preset residual power value. The battery residual power factor is between 0 and the medium value, and becomes larger with increase of the sensed battery residual power when the sensed battery residual power is between the first and second preset residual power values. The battery residual power factor is between the medium value and 1, and becomes larger with increase of the sensed battery residual power when the sensed battery residual power is between the second and third preset residual power values. It should be noted that the relation between the sensed battery residual power and the battery residual power factor may be non-linear when the sensed battery residual power is between the first and second preset residual power values or between the second and third preset residual power values.

The output module 23 receives the torque output signal from the output processing unit 2232, and includes a filter unit 231 operable to perform a filter operation on the torque output signal to obtain a control signal for controlling the output torque of the motor 32.

The preferred embodiment of the power control device 2 has the following advantages:

1. Through the starting compensation performed by the starting compensation unit 2222 when the starting condition judging unit 212 judges that the electric vehicle 3 is in the static starting state or the low-speed starting state, the static friction force applied on the electric vehicle 3 may be overcome, so as to alleviate the slow start of the electric vehicle 3.

2. Through the acceleration compensation performed by the acceleration compensation unit 2221 when the acceleration condition judging unit 211 judges that the electric vehicle 3 is in the accelerating state, acceleration response of the electric vehicle 3 may be improved.

3. Through the load compensation performed by the load compensation unit 2223 when the load condition judging unit 213 judges that the electric vehicle 3 is in the light load state or the heave load state, the output torque may vary with the load change of the electric vehicle 3.

4. The acceleration condition judging unit 211 makes the judgment of the acceleration condition according to the initial pedal depth, so as to prevent a sudden reduction of the output torque when the depth variation value becomes smaller than the preset value which may result in a sudden reduction of the vehicle speed.

5. The load condition judging unit 213 makes the judgment of the load condition according to the sensed vehicle speed, so that not only can the load change resulting from change of a road slope be sensed, but also the load change resulting from other reasons (such as a load on the electric vehicle 3) can be sensed as well, and the sensing of the road slope is not necessary.

6. The output processing unit 2232 generates the torque limit signal according to a state of the electric vehicle 3 (including the temperature of the motor 32, and the voltage, the temperature, and the residual power of the battery device 31), so that the value of the torque output signal will not be larger than that of the torque limit signal, thereby enhancing safety of the electric vehicle 3.

It should be noted that, in other embodiments, the condition judging module 21 may only include one or two of the acceleration condition judging unit 211, the starting condition judging unit 212, and the load condition judging unit 213. In this situation, the compensation device 222 may only include the corresponding one or two of the acceleration compensation unit 2221, the starting compensation unit 2222, and the load compensation unit 2223. In addition, the control processing unit 2231 may need a corresponding modification. For example, if the condition judging module 21 includes only the acceleration condition judging unit 211, and the compensation device 222 includes only the acceleration compensation unit 2221, the control processing unit 2231 uses the acceleration compensation signal as the compensation result, and generates the torque control signal based on a sum of the compensation result and the basic control signal when the compensation result is different from the compensation threshold value. As another example, if the compensation threshold value is 0, the condition judging module 21 includes only the acceleration condition judging unit 211, and the compensation device 222 includes only the acceleration compensation unit 2221, the control processing unit 2231 uses the acceleration compensation signal as the compensation result, generates the compensation result as the torque control signal when the compensation result is different from the compensation threshold value, and generates the basic control signal as the torque control signal when the compensation result is equal to the compensation threshold value.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A power control device for controlling output power of an electric vehicle, the electric vehicle including a motor, an accelerator pedal, and a sensing module, the sensing module being operable to sense a pedal depth of the accelerator pedal to provide a sensed pedal depth, and a vehicle speed of the electric vehicle to provide a sensed vehicle speed, said power control device comprising:
a condition judging module to be coupled to the sensing module and operable to make a judgment of at least one of an acceleration condition, a starting condition, and a load condition based on at least one of the sensed pedal depth and the sensed vehicle speed; and
a control module coupled to said condition judging module, to be coupled to the sensing module, and operable to generate a torque output signal according to the judgment made by said condition judging module and at least one of the sensed pedal depth and the sensed vehicle speed, wherein the torque output signal is for controlling an output torque of the motor;
wherein, for making the judgment of the acceleration condition, said condition judging module is operable to obtain a depth variation value according to the sensed pedal depth and a reference pedal depth, and to determine which one of an accelerating state and a non-accelerating state the electric vehicle is in according to the sensed pedal depth and the depth variation value;
wherein, for making the judgment of the starting condition, said condition judging module is operable to determine which one of a static starting state, a low-speed starting state, and a non-starting state the electric vehicle is in according to the sensed vehicle speed; and
wherein, for making the judgment of the load condition, said condition judging module is operable to determine which one of a light load state, a heavy load state, and a preset load state the electric vehicle is in according to the sensed pedal depth and the sensed vehicle speed.

2. The power control device as claimed in claim 1, wherein said condition judging module is operable to update the reference pedal depth according to the sensed pedal depth when determining which one of an accelerating state and a non-accelerating state the electric vehicle is in.

3. The power control device as claimed in claim 1, wherein, for making the judgment of the acceleration condition,
said condition judging module judges that the electric vehicle is in the accelerating state when the depth variation value is greater than a preset value, and sets an initial pedal depth using the reference pedal depth when said condition judging module judges that the electric vehicle has changed from the non-accelerating state to the accelerating state, and
said condition judging module judges that the electric vehicle is in the accelerating state when the depth variation value is less than the preset value and the sensed pedal depth is greater than the initial pedal depth, and judges that the electric vehicle is in the non-accelerating state and sets the initial pedal depth using a predetermined value when the depth variation value is less than the preset value and the sensed pedal depth is less than the initial pedal depth.

4. The power control device as claimed in claim 3, wherein the predetermined value is zero.

5. The power control device as claimed in claim 1, wherein, for making the judgment of the starting condition,
said condition judging module judges that the electric vehicle is in the static starting state when the sensed vehicle speed is less than a first preset speed;
said condition judging module judges that the electric vehicle is in the low-speed starting state when the sensed vehicle speed is between the first preset speed and a second preset speed larger than the first preset speed; and
said condition judging module judges that the electric vehicle is in the non-starting state when the sensed vehicle speed is larger than the second preset speed.

6. The power control device as claimed in claim 1, wherein, for making the judgment of the load condition,
said condition judging module judges that the electric vehicle is in the light load state when the sensed vehicle speed is larger by at least a preset difference from a preset speed that corresponds to the sensed pedal depth;
said condition judging module judges that the electric vehicle is in the heavy load state when the sensed vehicle speed is smaller by at least the preset difference from the preset speed that corresponds to the sensed pedal depth; and
said condition judging module judges that the electric vehicle is in the preset load state when the sensed vehicle speed is not larger by at least the preset difference from the preset speed that corresponds to the sensed pedal depth and is not smaller by at least the preset difference from the preset speed that corresponds to the sensed pedal depth.

7. The power control device as claimed in claim 1, wherein said control module includes:
a control unit operable to generate a basic control signal based upon the sensed pedal depth;
a compensation device operable to perform at least one of an acceleration compensation, a starting compensation, and a load compensation that corresponds to a respective one of the acceleration condition, the starting condition, and the load condition, and to generate at least one compensation signal; and
a processing device operable to generate the torque output signal based on the basic control signal and the compensation signal;
wherein, during the acceleration compensation,
when the electric vehicle is judged to be in the accelerating state, said compensation device generates an acceleration compensation signal having a value greater than that of the basic control signal according to the sensed pedal depth, and
when the electric vehicle is judged to be in the non-accelerating state, said compensation device generates the acceleration compensation signal having a first predetermined value;
wherein, during the starting compensation,
when the electric vehicle is judged to be in the static starting state, said compensation device generates a starting compensation signal having a preset compensation value;
when the electric vehicle is judged to be in the low-speed starting state, said compensation device generates the starting compensation signal according to the sensed vehicle speed; and
when the electric vehicle is judged to be in the non-starting state, said compensation device generates the starting compensation signal having a second predetermined value;
wherein, during the load compensation,
when the electric vehicle is judged to be in the light load state, said compensation device generates a load compensation signal having a value smaller than that of the basic control signal according to the sensed pedal depth;
when the electric vehicle is judged to be in the heavy load state, said compensation device generates the load compensation signal having a value greater than that of the basic control signal according to the sensed pedal depth; and
when the electric vehicle is judged to be in the preset load state, said compensation device generates the load compensation signal having a third predetermined value;
wherein the compensation signal generated by said compensation device is one of the acceleration compensation signal, the starting compensation signal, and the load compensation signal.

8. The power control device as claimed in claim 7, wherein each of the first, second, and third predetermined values is zero.

9. The power control device as claimed in claim 7, wherein said processing device includes:
a control processing unit operable to obtain a compensation result according to the compensation signal generated by said compensation device,
said control processing unit outputting a torque control signal based on the compensation result when the compensation result is different from a compensation threshold value,
said control processing unit outputting the torque control signal based on a sum of the compensation result and the basic control signal when the compensation result is equal to the compensation threshold value; and
an output processing unit operable to compare the torque control signal and a torque limit signal, and to output a smaller one of the torque control signal and the torque limit signal as the torque output signal.

10. The power control device as claimed in claim 9, the electric vehicle further including a battery device, the sensing module being further operable to sense at least one of a temperature of the motor, a voltage of the battery device, a temperature of the battery device, and a residual power of the battery device to provide at least one of a sensed motor temperature, a sensed battery voltage, a sensed battery temperature, and a sensed battery residual power, wherein:
said output processing unit is further operable to generate the torque limit signal according to at least one of the sensed motor temperature, the sensed battery voltage, the sensed battery temperature, and the sensed battery residual power from the sensing module.

11. The power control device as claimed in claim 9, wherein said condition judging module is operable to make the judgments of at least two of the acceleration condition, the starting condition, and the load condition, and said control processing unit is operable to obtain the compensation result based on a sum of the compensation signals corresponding to the judgments of said at least two of the acceleration condition, the starting condition, and the load condition.

12. The power control device as claimed in claim 1, further comprising an output module operable to output a control signal according to the torque output signal from said control module, wherein the control signal is for controlling the output torque of the motor.

13. The power control device as claimed in claim 12, wherein said output module includes a filter unit operable to perform a filter operation on the torque output signal to obtain the control signal.
